(19) United States
(12) Patent Application Publication
(10) Pub. No.: US 2006/0246945 A1
(43) Pub. Date: Nov. 2, 2006

(54) Display connected with cellular phone

(76) Inventor: Jae Ho Lee, Allendale, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/389,881

(22) Filed: Mar. 27, 2006

(30) Foreign Application Priority Data
Mar. 28, 2005 (KR) 10-2005-0025293

(51) Int. Cl. H04B 1/38; H04M 1/00

(52) U.S. Cl. 455/557; 455/550.1; 455/566

(57) ABSTRACT

Disclosed herein is a display connected to a cellular phone and a mounting structure between the display and the cellular phone. The display connected to the cellular phone, which can provide at least one of GPS/navigation, DMB, moving picture, and game services, includes: a cellular phone having a male socket part formed on the lower portion thereof; a mounting member having a mounting space with a form corresponding to a form of the lower portion of the cellular phone, a female socket part supported on the bottom surface of the mounting space and coupled to the male socket part, and a guide part; and a display unit having a phone body space formed on the rear surface thereof, the phone body space being depressed in a form corresponding to the form of the mounting member and a body of the cellular phone.

### CROSS-REFERENCE TO RELATED APPLICATION

This application claims the priority of Korean Patent Application No. 10-2005-0025293 filed Mar. 28, 2005, the disclosure of which is incorporated herein by reference in its entirety for all purposes.

### BACKGROUND OF THE INVENTION

1. Field of the Invention

The present invention relates to a display connected with a cellular phone, and more particularly, to a display connected with a cellular phone which is mounted on the rear surface of the display to realize simplicity in configuration.

In the present invention, in view of the present technical level in Korea and in the world, a display means a device capable of being electromagnetically connected with a cellular phone and achieving a screen output in response to an electromagnetic output of the cellular phone, for instance, CRT monitors, LCD monitors, OLEDs, PDP panels, and so on. Furthermore, as cellular phones and displays are developed, the display includes screen output means capable of providing the same output as a liquid crystal screen belonging to the cellular phone when the screen output means is connected with the cellular phone or providing a function of a touch screen.

In the present invention, G.P.S is an abbreviation of global positioning system, and navigation is a service to provide way guidance, restricted areas and information of surrounding environments through a predetermined program including a map data based on location information by the GPS in the cellular phone having a GPS function or a GPS module. In the present invention, a GPS/Navigation service means a service to provide a navigation service based on a GPS receiving function.

In the present invention, a Digital Multimedia Broadcasting (DMB) service means a broadcasting service to provide a portable receiver with various multimedia signals such as a sound signal and an image signal in a digital type, and is classified into a terrestrial DMB, a satellite DMB, and a combined type DMB in which the terrestrial DMB and the satellite DMB are combined with each other.

2. Background Art

In general, a cellular phone is used for voice call or message transmission, but recently, the use of GPS/navigation service, satellite DMB service, moving picture service, and so on through the cellular phone has been gradually increased.

Presently, according to a highly functional structure of the cellular phone, cellular phones, which permits mounting of GPS module or has a GPS function, have been disclosed. Since the cellular phone has a function of a GPS receiver, most of mobile service providers in Korea provide the navigation service through wireless communication network to wanted users. In this case, a base station of the mobile service provider transmits location information and geographical information in an electromagnetic signal to the cellular phone, and the information is provided to the user through visual means such as a screen or auditory means such as a speaker of the cellular phone. In Korea, a device having a display for providing only GPS/navigation service is used commonly.

When a user uses the cellular phone for voice call or message transmission within several minutes, the cellular phone executes information input (number, message) by buttons and information output (number, message) on the screen, or voice input through microphone and a partner's voice output through the speaker. In this case, input by the cellular phone user and screen output by the input are achieved at the same time, or there is little interval between input time and output time. Moreover, the time period for using the cellular phone is short.

Therefore, in the above case, the buttons of the cellular phone must be located at a place where the user is easily accessible to the buttons with a simple action, and the user does not feel fatigue in eyes even though the screen of the cellular phone is small since the time period when the user watches the screen is not long.

However, as described above, recently, the use of G.P.S/navigation service, satellite DMB service, moving picture service, and so on through the cellular phone has been gradually increased. In this case, the time period for inputting a process to connect with a wanted service using the buttons is short, but the user has to continuously watches the screen for a long time since the base station of the mobile service provider continuously provides signal input to the user's cellular phone after the cellular phone is connected to the wanted service.

In the above case, the user feels fatigue due to the long-term watching of the small-sized LCD screen of the cellular phone, and is not satisfied with the cellular phone with the small-sized LCD screen. Additionally, the conventional cellular phone has another disadvantage in that a position of the display part is not easily adjusted and it is difficult to secure a visual field since a phone body and the display part are formed integrally with each other. Particularly, the conventional cellular phone has a further disadvantage in that the user may be faced with danger of incidents while concentrating on information displayed on the small-sized screen when the user uses the G.P.S/navigation service using the cellular phone.

### SUMMARY OF THE INVENTION

Accordingly, the present invention has been made to solve the above problems occurring the prior art, and it is an object of the present invention to provide a display connected with a cellular phone, which can display the same information as a display equipped on the cellular phone in the degree of enlargement in order to enhance a user's satisfaction level in watching an output screen, and which can adjust a position of a display part in order to permit the user to easily secure a visual field.

It is another object of the present invention to provide a display connected with a cellular phone, which can prevent that the user may be faced with danger of incidents while concentrating on information displayed on the small-sized screen when the user uses the GPS/navigation service using the cellular phone.

It is a further object of the present invention to provide a display connected with a cellular phone, which can detachably mount the cellular phone on the rear surface of the display, thereby effectively utilizing a space and promoting simplicity and durability in coupling ob the display and the cellular phone

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1a is a perspective view of the rear side of a cellular phone according to the present invention;

FIG. 1b is a perspective view of the lower part of the cellular phone of FIG. 1a;

FIG. 2 is a perspective view of the rear side of a display according to the present invention;

FIG. 3 is a perspective view of the rear side of the display in a state where the cellular phone is mounted on a side of the display according to the present invention;

FIG. 4 is a rear view showing a state where the cellular phone is mounted at the center if the display according to the present invention;

FIG. 5 is a front view of the display of a touch screen type; and

FIG. 6 is a perspective view showing the rear side of the cellular phone according to another embodiment of the present invention.

### DETAILED DESCRIPTION OF THE PREFERRED EMBODIMENT

Reference will be now made in detail to the preferred embodiment of the present invention with reference to the attached drawings.

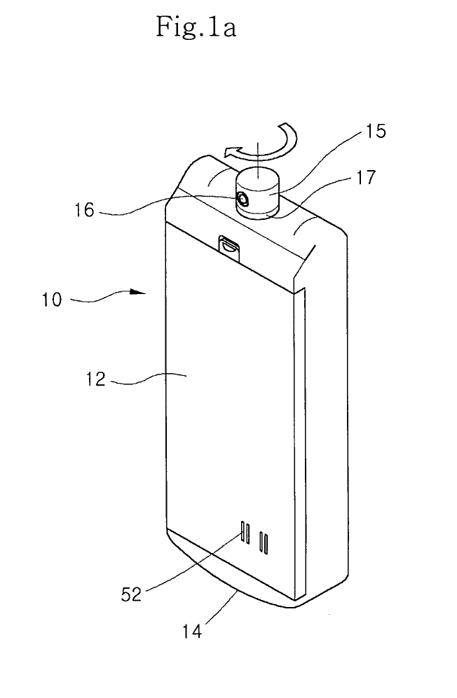

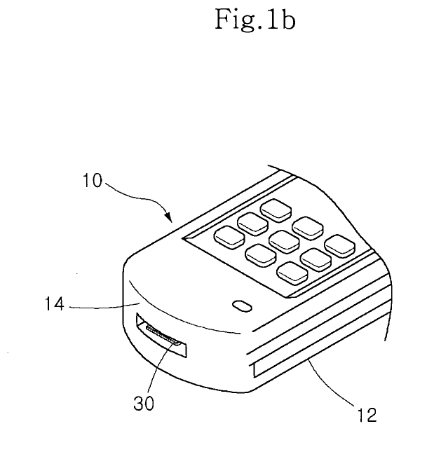

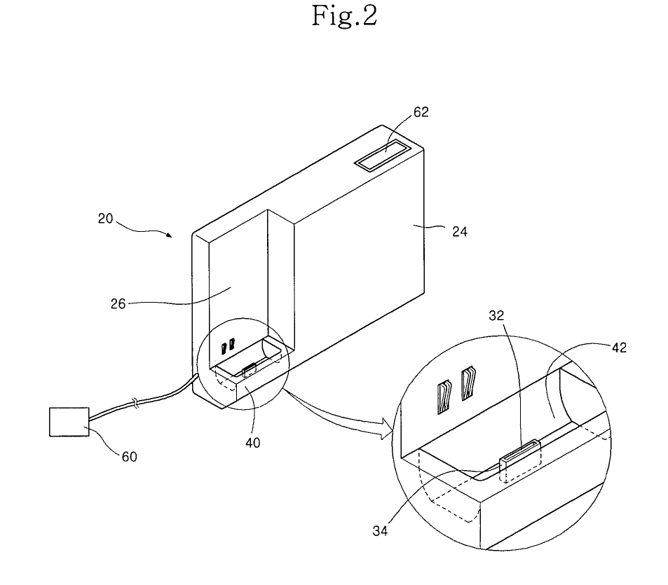

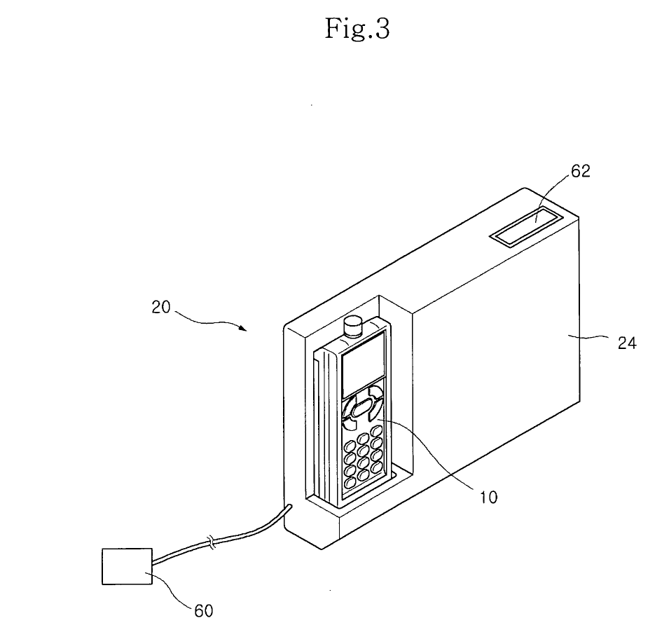

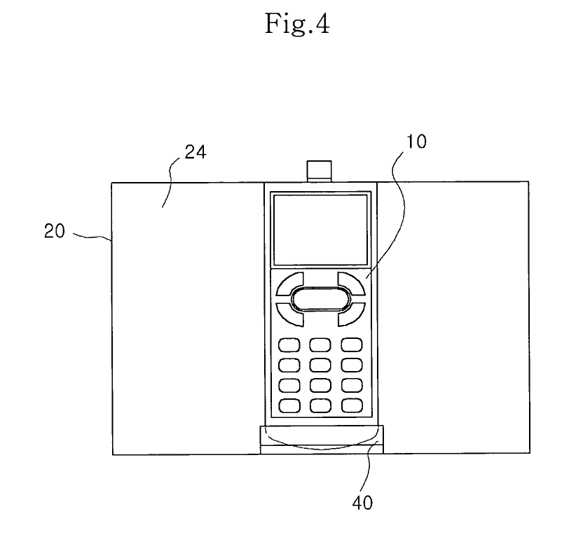

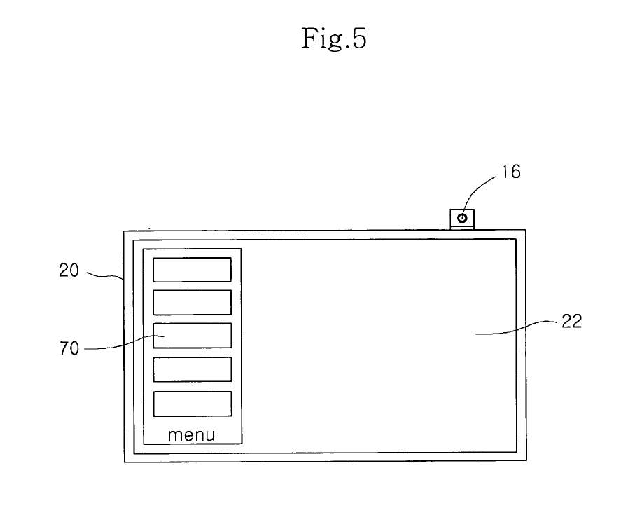

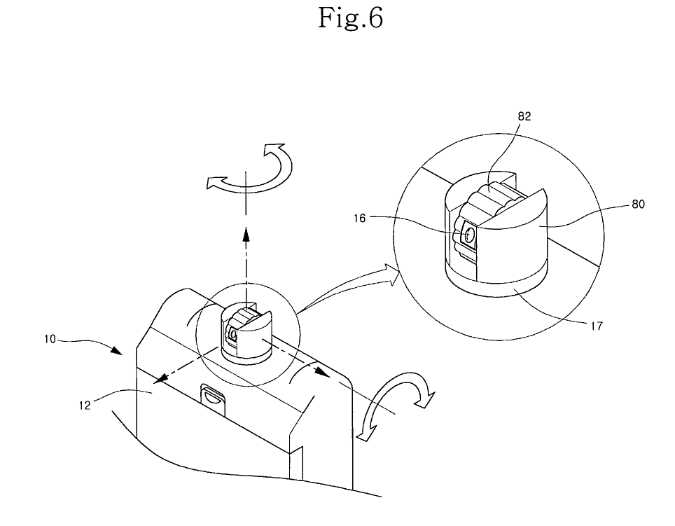

FIG. 1a is a perspective view of the rear side of a cellular phone according to the present invention, FIG. 1b is a perspective view of the lower part of the cellular phone of FIG. 1a, FIG. 2 is a perspective view of the rear side of a display according to the present invention, FIG. 3 is a perspective view of the rear side of the display in a state where the cellular phone is mounted on a side of the display according to the present invention, FIG. 4 is a rear view showing a state where the cellular phone is mounted at the center if the display according to the present invention, FIG. 5 is a front view of the display of a touch screen type, and FIG. 6 is a perspective view showing the rear side of the cellular phone according to another embodiment of the present invention.

According to a preferred embodiment of the present invention, the display connected to the cellular phone, which can provide at least one of a Global Positioning System (GPS)/navigation, Digital Multimedia Broadcasting (DMB), moving picture, and game services, includes: a cellular phone 10 having a male socket part 30 formed on the lower portion 14 thereof; a mounting member 40 having a mounting space 42 with a form corresponding to a form of the lower portion 14 of the cellular phone 10, a female socket part 32 supported on the bottom surface of the mounting space 42 and coupled to the male socket part 30, and a guide part 34; and a display unit 20 having a phone body space 26 formed on the rear surface thereof, the body space 26 being depressed in a form corresponding to the form of the mounting member 40 and a body of the cellular phone 10. The display may selectively have an external power supply device 60 or a battery 62 which is embedded in the display.

FIG. 1a is a perspective view of the rear side of a cellular phone according to the present invention. As shown in FIG. 1a, the cellular phone 10 includes a camera mounted on the upper portion thereof, and a rechargeable terminal 52 formed on the rear surface 12 thereof. A body 15 of the camera is adjacent to a rotation guidance part 17 for rotating the camera on the upper portion of the cellular phone 10, and is located at a place where a lens 16 of the camera is shown from the front surface 22 of the display even when the cellular phone 10 is mounted on the display unit 20. In FIG. 1a, the camera body 15 and the rotation guidance part 17 are in a cylindrical form and rotated in contact with each other. Besides the above configuration, one of camera rotating means used commonly in Korea may be applied to the cellular phone. Since the camera body 15 is rotated on the rotation guidance part 17, the camera lens 16 ca be rotated to an angle of about 360° even in a state where the position of the cellular phone 10 is fixed by applying some torque to the camera body 15. The cellular phone 10 may be one of most cellular phones such as folder type cellular phones whose the phone body and an LCD screen can be moved, slide type cellular phones, and flip type cellular phones whose phone body and the LCD screen are formed integrally with each other.

FIG. 1b is a perspective view of the lower part of the cellular phone of FIG. 1a. As shown in FIG. 1b, the male socket part 30 is located on the lower portion 14 of the cellular phone 10. The male socket part 30 includes a number of terminals for transmitting electric signals, and preferably, is in the form of a thin plate. However, the male socket part 30 may be in a form that a number of small cylindrical rods are protruded. Alternatively, it would be appreciated that the male socket part 30 can be formed in one of various shapes and made of one of various materials according to a user's intention if the male socket part 30 can transmit output signals of the cellular phone (for example, electricity, a VGA signal, a control signal, and so on) to the display.

FIG. 2 is a perspective view of the rear side of a display according to the present invention. As shown in FIG. 2, the surface on which screen output is displayed is the front surface of the display, and the other surface is the rear surface 24 of the display. In consideration of convenience in watching, it is preferable that a ratio of a width to a length of the display is 4:3-16:9, but the display may have another ratio, and a size of the display is 2.5″-12″ or more. Referring to FIG. 5, the display unit 20 may be of a touch screen type. The display unit 20 includes the mounting member 40 formed on the rear surface thereof.

As shown in FIG. 2, the display unit 20 includes the phone body space 26 which is depressed from a flat portion of the rear surface in order to keep flatness of the outward appearance without protrusion even when the cellular phone 10 is mounted on the mounting member 40 of the rear surface of the display unit 20. The phone body space 26 has the form corresponding to the form of the phone body, and can be located at any place of the rear surface of the display unit 20. Preferably, the phone body space 26 is located at both sides or at the center of the rear surface of the display unit 20.

As shown in FIG. 2, the mounting member 40 has the mounting space 42 with the form corresponding to the form of the lower portion of the cellular phone 10. The female socket part 32 and the guidance part 34 are supported on the bottom surface of the mounting space 42, and have the form corresponding to the from the male socket part 30. The mounting member 40 is formed integrally with the rear surface of the display unit 20 or detachably mounted on the rear surface of the display unit 20.

Hereinafter, power supply to the display unit 20 will be described. As shown in FIG. 2, the display unit 20 can be connected to the external power supply device 60. The supplied electricity is used for actuation of the display unit 20 ad the cellular phone 10 or recharging of the cellular phone 10. In the case of a car, a battery or an alternator for the car serve as the power supply device 60. Moreover, the display unit 20 can embed a battery 62 therein. In the case where it is difficult to use the external power supply device 60, the built-in battery 62 can serve as the power supply device 60. The display unit 20 may have a high quality speaker such as 5.1 channel as sound output means so as to obtain sound output of high quality.

FIG. 3 is a perspective view of the rear side of the display in a state where the cellular phone is mounted on a side of the display according to the present invention, and FIG. 4 is a rear view showing a state where the cellular phone is mounted at the center if the display according to the present invention.

As shown in FIG. 3, the cellular phone 10 can be mounted at one of both sides of the rear surface 24 of the display unit 20. In this case, the display unit is easy in use since the user can detachably mount the cellular phone 10 through a vertical edge of the display unit 20, and is simple in structure and effective in space utilization since the rear surface 24 of the display unit is formed in consideration that the central portion is protruded more than the side portion. The rear part of the display unit on which the cellular phone 10 is mounted is generally in the flat form since the cellular phone 10 is contained in the phone body space 26.

As shown in FIG. 4, the cellular phone 10 can be mounted at the center of the rear surface 24 of the display unit 20. In this case, the user can detachably mount the cellular phone 10 through the center of the horizontal edge of the upper end of the display unit 20.

FIG. 5 is a front view of the display of a touch screen type. As shown in FIG. 5, the display unit 20 is the touch screen type. The display unit 20 can display a menu serving as the buttons of the cellular phone 10 on the screen by using a predetermined software and a touch panel, so that the user can use the function of the cellular phone 10 by manipulating the menu 70 displayed on the screen of the display unit 20 without using the buttons of the cellular phone 10 even when the cellular phone is folded.

FIG. 6 is a perspective view showing the rear side of the cellular phone according to another embodiment of the present invention. As shown in FIG. 6, the cellular phone 10 has the camera mounted on the upper portion thereof, and the camera includes the rotation guidance part 17, horizontally rotating means 80, and vertically rotating means 82 having the camera lens 16.

The rotation guidance part 17 is located in contact with the upper portion of the cellular phone 10, and is in a disc type.

The horizontally rotating means 80 is in contact with a side opposed to a side contacting with the upper portion of the camera of the rotation guidance part 17 and supported by the rotation guidance part 17, and has an empty space formed in the center thereof. Moreover, the horizontally rotating means 80 can rotate the camera to about 360° against the rotation guidance part 17 on a rotary axis which is a line parallel with a vertically central line of the cellular phone 10.

The vertically rotating means 82 has the camera lens 16, is located at the space formed in the center of the horizontally rotating means 80, supported by the horizontally rotating means 80, and has a cylindrical form. The vertically rotating means 82 has regularly-formed uneven portions, like a sprocket having soft teeth, formed on the outer periphery thereof. The vertically rotating means 82 can rotate the camera to about 360° against the horizontally rotating means 80 on a rotary axis which is a central line of the cylinder type vertically rotating means 82 or a line connecting two support points positioned at the horizontally rotating means 80.

Hereinafter, the operation of the display connected with the cellular phone according to the present invention will be described.

The display unit 20 serves to display visual output on the screen according to an electrical input signal from the cellular phone 10. The display unit 20 can provide convenience and satisfaction in watching since it displays the same information as a small-sized screen of the cellular phone but provides the enlarged screen. The phone body space 26 formed on the rear surface of the display unit 20 is a space for containing the cellular phone.

The socket parts 30 and 32 of the present invention serve as a connector to transmit an output signal from the cellular phone to the display unit 20. Furthermore, mechanical power to prevent drop of the cellular phone after the cellular phone is mounted on the display is generated by coupling the female socket part 32, the guidance part 34 and the male socket part 30 of the cellular phone 10.

The mounting member 40 together with the mounting space 42 and the coupled socket parts 30, 32 and 34 serves to support and fasten the cellular phone 10 mounted on the display unit 20.

The rechargeable terminal 52 recharges the cellular phone, and the power supply device 60 and the battery 2 supply electricity to the display unit 20 or the cellular phone 10.

The menu 70 of the touch screen type provides functions equal or similar to the input buttons of the cellular phone 10.

While the present invention has been described with reference to the particular illustrative embodiments, it is to be appreciated that those skilled in the art can change or modify the embodiments without departing from the scope and spirit of the present invention. For instance, as the display unit 20, a display element such as an organic EL can be used instead of a CRT or LCD monitor, and it can be achieved easily by those skilled in the art from the above embodiments of the present invention.

As described above, the display unit 20 according to the present invention displays the same information as the small-sized screen of the cellular phone on the enlarged screen. Therefore, differently from the small-sized screen of the cellular phone, the display according to the present invention can provide the user with convenience and satisfaction in watching when the user watches the screen for a long time while the cellular phone provides the GPS/navigation service, D.M.B service or moving picture service. Particularly, the display according to the present invention can reduce incidents since the user can easily see information displayed on the screen at a predetermined interval when the GPS/navigation service is provided through the cellular phone. Moreover, the display according to the present invention can effectively utilize the GPS/navigation service, DMB service or moving picture service of expensive price since other persons near to the cellular phone user can see the service displayed on the display unit 20. Therefore, the display according to the present invention can prevent the user's fatigue in eyes and unsatisfaction in watching, and danger of traffic accidents caused by the small-sized screen of the conventional cellular phone, when the GPS/navigation service, D.M.B service or moving picture service is provided through the cellular phone.

As described above, the present invention relates to the display unit 20 connected to the conventional cellular phone 10. The user has to input using the buttons of the cellular phone 10 to connect with the GPS/navigation service, DMB service or moving picture service, but it is not necessary that the front surface of the cellular phone 10 having the buttons is located at a place, where the user is easily accessible, after the input. In this case, if the cellular phone 10 and the display unit 20 are just connected by connecting means such as a cable but spaced apart from each other, it causes inefficiency in space and inconvenience that the user cannot find the cellular phone. However, the present invention can utilize space effectively, provide simplicity and firmness in coupling between the cellular phone and the display unit, and allow the user to easily find the cellular phone when the user has to answer the telephone during driving in a car, since the cellular phone 10 is detachably mounted on the rear surface of the display unit 20.

Additionally, the present invention can promote efficiency in power use since the present invention adopts the independent power supply means 60 and 62 and cellular phone recharging means.

The scope of the present invention is not to be restricted by the embodiments but only by the appended claims, and changes and modifications within the scope of the claims belongs to the scope of the present invention.

What is claimed is:

1. A display connected to a cellular phone, which can provide at least one of Global Positioning System (GPS)/navigation, Digital Multimedia Broadcasting (DMB), moving picture, and game services, comprising:
a cellular phone having a male socket part formed on the lower portion thereof;
a mounting member having a mounting space with a form corresponding to a form of the lower portion of the cellular phone, a female socket part supported on the bottom surface of the mounting space and coupled to the male socket part, and a guide part; and
a display unit having a phone body space formed on the rear surface thereof, the phone body space being depressed in a form corresponding to the form of the mounting member and a body of the cellular phone.

2. The display connected to a cellular phone according to claim 1, wherein the mounting member is formed at both sides or at the center of the rear surface of the display unit.

3. The display connected to a cellular phone according to claim 1, wherein the display unit further includes an external power supply device or a built-in battery selectively or together.

4. The display connected to a cellular phone according to claim 1, wherein the display unit is of a touch screen type.

5. The display connected to a cellular phone according to claim 1, wherein the cellular phone further includes:
a disc type rotation guidance part located in contact with the upper portion thereof;
horizontally rotating means being in contact with a side opposed to a side contacting with the upper portion of the camera of the rotation guidance part, and supported by the rotation guidance part, the horizontally rotating means having an empty space formed in the center thereof, and rotating the camera to about 360° against the rotation guidance part on a rotary axis which is a line parallel with a vertically central line of the cellular phone; and
vertically rotating means having a camera lens, located at the space formed in the center of the horizontally rotating means, supported by the horizontally rotating means, and having a cylindrical form, the vertically rotating means having regularly-formed uneven portions, like a sprocket having soft teeth, formed on the outer periphery thereof, the vertically rotating means rotating the camera to about 360° against the horizontally rotating means on a rotary axis which is a central line of the cylinder type vertically rotating means or a line connecting two support points positioned at the horizontally rotating means.
